(19) United States
(12) Patent Application Publication
(10) Pub. No.: US 2019/0351465 A1
(43) Pub. Date: Nov. 21, 2019

(54) LABORATORY FUME HOOD HAVING WALL JETS

(71) Applicant: Waldner Laboreinrichtungen GmbH & Co., KG, Wangen Im Allgäu (DE)

(72) Inventors: Jürgen Liebsch, Scheidegg (DE); Christian Oliver Paschereit, Berlin (DE)

(21) Appl. No.: 16/474,156

(22) PCT Filed: Dec. 28, 2017
(86) PCT No.: PCT/EP2017/084704

§ 371 Date: Jun. 27, 2019

(30) Foreign Application Priority Data
Dec. 29, 2016 (DE) 10 2016 125 890.3

(51) Int. Cl. B08B 15/02; F24F 3/16

(52) U.S. Cl. CPC B08B 15/023; B08B 2215/003; F24F 3/1607

(57) ABSTRACT

The present invention relates to a fume cupboard 1 for a laboratory, which fume cupboard has a housing 60 in which a work area is located, delimited in the front by a front sash 30, at the bottom by a bottom plate 34 and on each side by a side wall 36. The fume cupboard 1 further comprises a first hollow profile 10, 10′ disposed on a frontal end face of each side wall 36, wherein each first hollow profile 10, 10′ contains a first pressure chamber 10b, 10b′ which is in fluid communication with a multiplicity of first openings 10d, 10d′, from which air jets in the form of wall jets 100 consisting of compressed air may be output into the work area along the respective side wall 36. The fume cupboard is characterized in that the size of the first openings 10d, 10d′ and the air pressure that prevails in the first pressure chamber 10b, 10b′ during proper user of the fume cupboard are selected such that the first pressure chamber 10b, 10b′ can be connected fluidically to a compressed air system 74 installed in the building without causing airflow delamination of the wall jets 100 from the side wall 36 in a region extending from a front side of the work area at least as far as 25% of the depth of the work area.

The present invention further relates to a fume cupboard in which a hollow profile 20, 20′ of such kind is disposed on a front frontal end face of the bottom plate 34.

The present invention concerns itself with a fume cupboard, particularly a flow-optimized, energy-efficient fume cupboard.

Energy conservation is not only environmentally responsible, it also helps to lower the sometimes very high operating costs of a modern laboratory, in which it is not unusual for dozens of fume cupboards to be installed, each running 24 hours a day, 7 days a week. However, the most important quality of modern fume cupboards still consists in that they make it possible to work safely with toxic substances and prevent such substances from escaping from the work area of the fume cupboard. The measure of this safety is also called retention capacity. For this purpose, a detailed series of standards, “EN14175 Part 1 to Part 7” has been published, which among much else describes the effect of dynamic airflows on retention capacity. Many developments in the technical area of fume cupboards are therefore intended to address the question of how the energy consumption of such fume cupboards can be reduced without diminishing their retention capacity.

As early as the 1950s, attempts were being made to improve the escape prevention capability of fume cupboards using an “air curtain”. This air curtain is created with the aid of air outlet nozzles provided on the side walls of the fume cupboard in the area of the front sash opening and is intended to prevent toxic fumes from getting out of the work area (U.S. Pat. No. 2,702,505 A).

In EP 0 486 971 A1 it was suggested to provide deflectors (“air foils”) with a flow-optimized contour on the front edge of the side columns and the front edge of the work plate. According to the teaching of EP 0 486 971 A1, these deflectors were designed to reduce delamination of the inflowing ambient air on the leading surface of the deflectors when the sash was open, and thus cause less turbulence. However, there is still an area behind these deflectors where turbulence can arise, because the inflowing ambient air can delaminate at the downstream end of the deflectors. This effect occurs with greater strength if ambient air flows into the fume cupboard at an angle to the side walls.

In GB 2 336 667 A, the retention capacity was improved further by providing profiles in the form of bearing surfaces at a distance from the front edge of the work plate and the side columns, so that ambient air is able to enter the interior of the fume cupboard not only along the profiles in the form of bearing surfaces but also through the usually funnel-like gap which exists between the profiles and the front edge of the work plate on one side and the side columns on the other The ambient air is accelerated in the funnel-like gap, so that the velocity profile of the exhaust gas is increased in the region of the side walls and the work plate.

A further milestone in increasing escape prevention while at the same time reducing the energy consumption of a fume cupboard was reached with the optimized supply of “stabilizer jets”. Since hollow profiles are provided both at the front edge of the work plate and on the frontal end faces of the side columns, it was possible to feed compressed air into the cavity in these profiles and blow it into the work area through openings provided in the hollow profiles in the form of compressed air jets. The advantage of this is that the stabilizer jets consisting of compressed air enter the work area of the fume cupboard along the side walls and along the work plate, i.e. along the regions which are critical in terms of the risk of turbulence (backflow areas) and can therefore detrimentally affect retention capacity. The compressed air jets in the region of the side walls and the bottom of the work area have several effects. Not only do they prevent delaminations of the incoming flows of air from the room at the downstream end of the hollow profiles, they also reduce any friction effects with the walls, so that turbulence and therewith also backflow areas are significantly reduced in these regions. The ambient air entering the work area slides as it were over dynamic cushion of air which moves backwards along the walls and the work plate towards the rear of the work area, where it is drawn out. At first glance, this seems contradictory, since the provision of compressed air jets uses more energy. However, it does affect the total energy balance of the fume cupboard positively, because the air velocity can be slowed in the other regions of the fume cupboard interior without impairing its retention capacity. With these stabilizer jets, the minimum quantity of exhaust air needed to ensure that the escape prevention capability of the fume cupboard fulfills the standardized regulations could be reduced with the front sash partly or fully open. An example of a fume cupboard equipped with stabilizer jet technology is described in DE 101 46 000 A1, EP 1 444 057 B1 and U.S. Pat. No. 9,266,154 B2.

While examining the flow field of the wall jets using “Particle Image Velocimetry” (PIV) measurements in fume cupboards equipped with conventional stabilizer jet technology, the inventors of the present invention were the first to observe that, in contrast to previous experiments with mist, in which no significant airflow delamination of the wall jets was detected, airflow delamination takes place a relatively short distance behind the plane of the front sash and dangerous backflow areas may consequently form at the side walls.

The main objective pursued with the present invention therefore consists primarily in further improving the escape prevention capability of a fume cupboard equipped with stabilizer jet technology, and at the same time further reducing its energy consumption.

This objective is solved with the features of claims 1 and 2. Optional or preferred features of the invention are described in the dependent claims.

Accordingly, the invention describes a fume cupboard for a laboratory, which fume cupboard has a housing in which a work area is located, delimited in the front by a front sash, at the bottom by a bottom plate and on each side by a side wall. The fume cupboard further comprises a first hollow profile disposed on a frontal end face of each side wall, wherein each first hollow profile contains a first pressure chamber which is in fluid communication with a multiplicity of first openings, from which air jets in the form of wall jets consisting of compressed air may be output into the work area along the respective side wall. The fume cupboard is characterized in that the size of the first openings and the air pressure that prevails in the first pressure chamber during proper user of the fume cupboard are selected such that the first pressure chamber can be connected fluidically to a compressed air system installed in the building without the side wall causing airflow delamination of the wall jets in a region extending from a front side of the work area at least as far as 25% of the depth of the work area.

On the other hand, the invention also provides a fume cupboard for a laboratory, which fume cupboard has a housing in which a work area is located, delimited in the front by a front sash, at the bottom by a bottom plate and on each side by a side wall. The fume cupboard further comprises a second hollow profile disposed on a frontal end face of the bottom plate, wherein the second hollow profile contains a second pressure chamber which is in fluid communication with a multiplicity of second openings, from which air jets in the form of bottom jets consisting of compressed air may be output into the work area along the bottom plate. The fume cupboard is characterized in that the size of the second openings and the air pressure that prevails in the second pressure chamber during proper user of the fume cupboard are selected such that the second pressure chamber can be connected fluidically to a compressed air system installed in the building without the bottom plate causing airflow delamination of the bottom jets in a region extending from a front side of the work area at least as far as 25% of the depth of the work area.

It is advantageous if the fume cupboard is equipped with both a first hollow profile and a second hollow profile.

According to a preferred embodiment of the invention, no airflow delamination of the wall jets from the side wall or of the bottom jets from the bottom plate occurs in the fume cupboard in a region extending from the front side of the work area at least as far as 50% of the depth of the work area.

More preferably, no airflow delamination of the wall jets from the side wall or of the bottom jets from the bottom plate occurs in the fume cupboard in a region extending from the front side of the work area at least as far as 75% of the depth of the work area.

Also preferably, a first and/or a second pressure transducer is/are provided which communicate(s) fluidically with the first and/or second pressure chamber.

According to an advantageous variant of the invention, the first and/or second pressure transducer comprises a first and/or second pressure transducer line, which is/are arranged in such manner that an end of the first and/or second pressure transducer line on the pressure chamber side terminates flush with an inner surface of the first and/or second pressure chamber.

It is also advantageous if a control device is provided which during proper operation of the fume cupboard sets the pressure of the in the first and/or second pressure chamber in a range from 50 Pa to 500 Pa, preferably in range from 150 Pa to 200 Pa.

The control device is preferably connected electrically to the first and/or second pressure transducer.

It is still more preferable if the control device is a pressure reducer or a mass flow controller which is arranged upstream of the first and/or second pressure chamber.

According to a further preferred embodiment of the invention, the pressure reducer or mass flow controller is disposed inside the housing.

When viewed at right angles to the direction of flow, a cross-sectional area of at least one of the first and/or second openings, preferably of all first and/or second openings, preferably lies in a range from 1 mm² to 4 mm².

When viewed at right angles to the direction of flow, a cross-sectional area of at least one of the first and/or second openings, preferably of all first and/or second openings, more preferably lies in a range from 1.8 mm² to 3 mm².

An advantageous variant of the fume cupboard is realized when at least one of the first and/or second openings, preferably all of the first and/or second openings is/are designed in such manner that the jet of compressed air exiting the first and/or second opening is delivered into the work area as a periodically oscillating wall jet (100) and/or as a periodically oscillating bottom jet (200).

It is also advantageous if the periodicity is in a range from 1 Hz to 100 kHz, preferably 200 Hz to 300 Hz.

According to a further preferred embodiment of the invention, the periodic oscillation of the wall jet and/or the bottom jet is generated entirely by non-moving components of the first and/or second hollow profile, which are preferably constructed as single parts.

It is preferable if the periodic oscillation of the wall jet and/or the bottom jet is generated by self-excitation.

It is also advantageous if at least one first and/or one second fluidic oscillator is/are provided, which comprise(s) the first and/or second opening, preferably a multiplicity of first and/or second fluidic oscillators are provided, each of which comprises a first and/or second opening, and which generate(s) the periodic oscillation of the wall jet/wall jets and/or the periodic oscillation of the bottom jet/bottom jets.

It is preferable if the first and/or second openings have a circular, round, oval, rectangular or polygonal shape.

One advantageous variant of the invention relates to a fume cupboard which is characterized in that at least one first and/or one second opening is fluidically connected to the first and/or second pressure chamber via a first and/or second elongated duct, and that the first and/or second duct has a length L, which is at least three times, preferably 4 times up to 11 times the length of the hydraulic diameter of a cross-sectional surface of the associated opening viewed at right angles to the direction of flow.

The invention will now be explained purely for exemplary purposes with reference to the accompanying drawing. In the drawing:

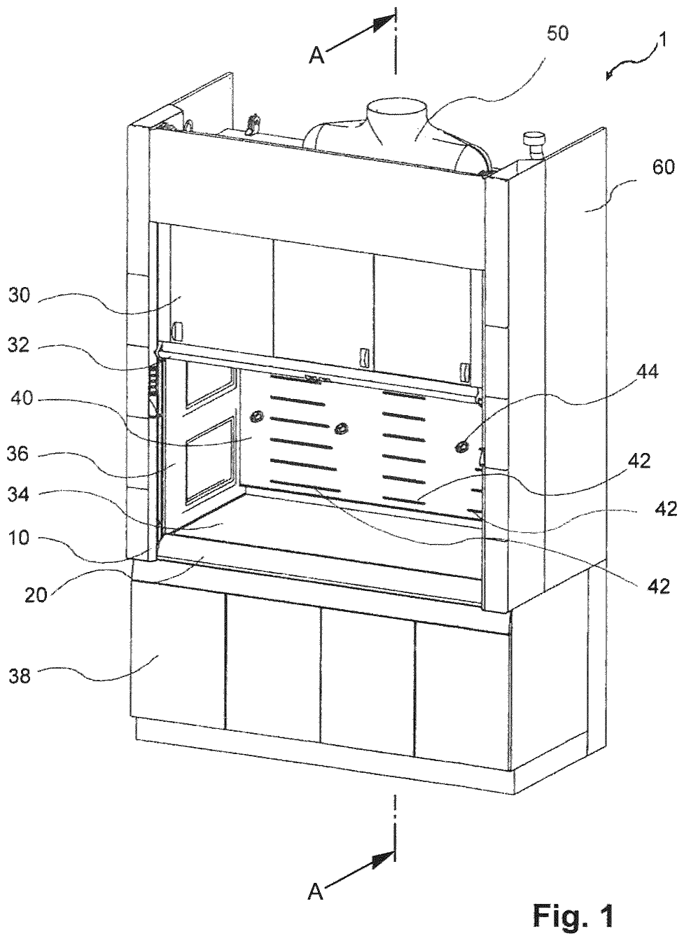

FIG. 1 is a perspective view of a conventional fume cupboard;

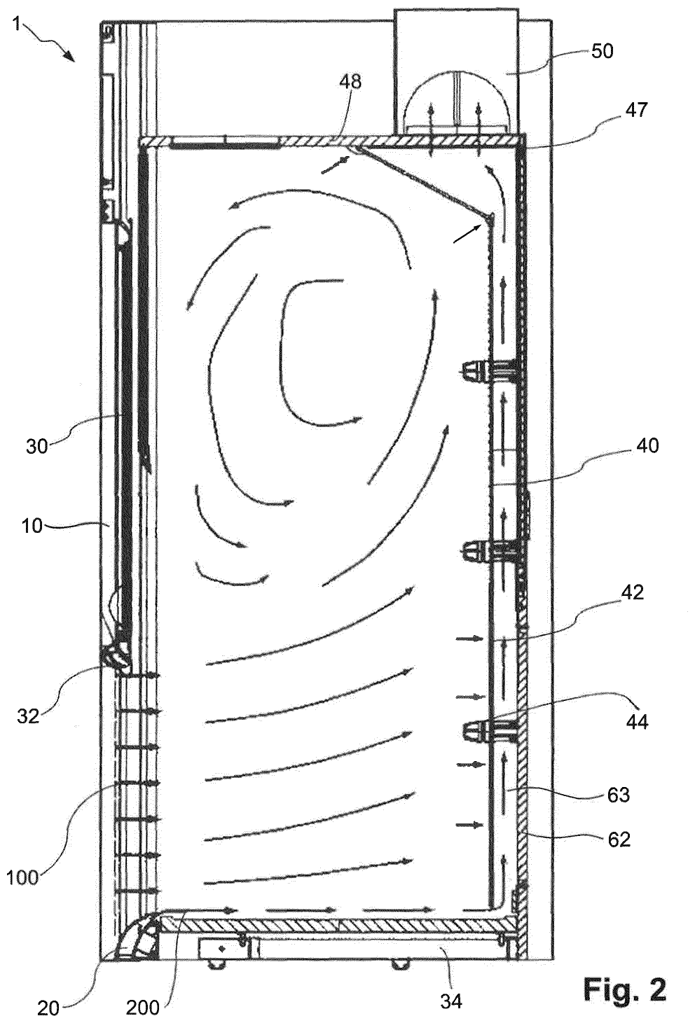

FIG. 2 is a cross-sectional view of the fume cupboard represented in FIG. 1 along line A-A in FIG. 1;

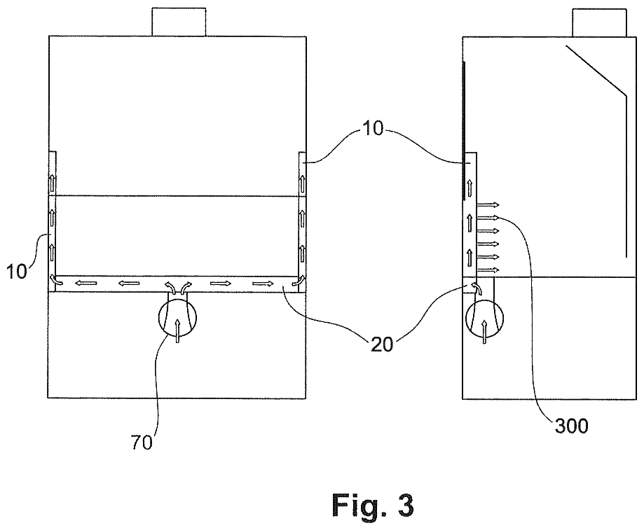

FIG. 3 shows the feed of compressed air into the side column profiles and the bottom plate profile;

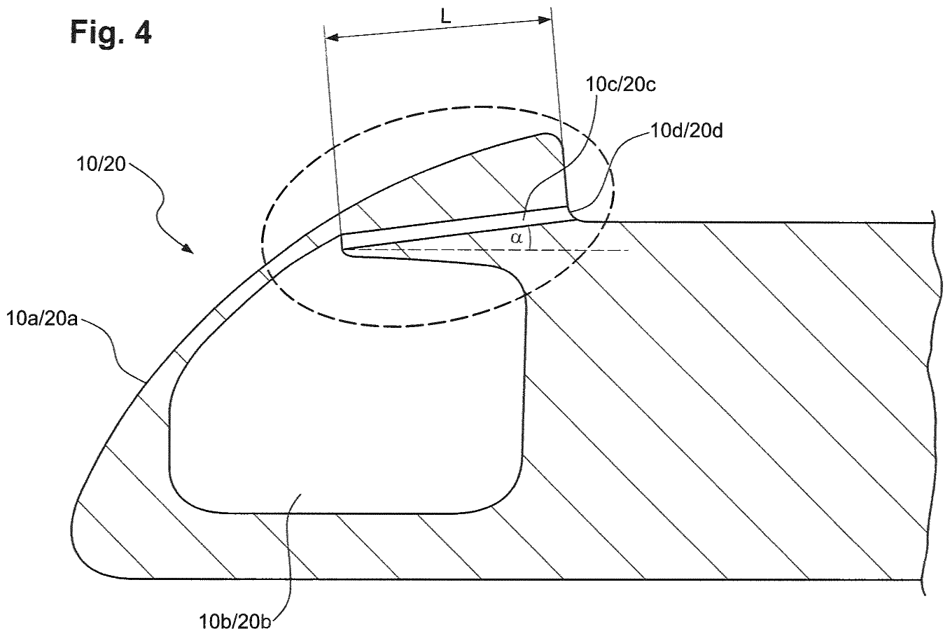

FIG. 4 is a cross-sectional view of a hollow profile according to the invention, which is disposed at the frontal end face of the side wall and/or on the frontal face of the bottom plate;

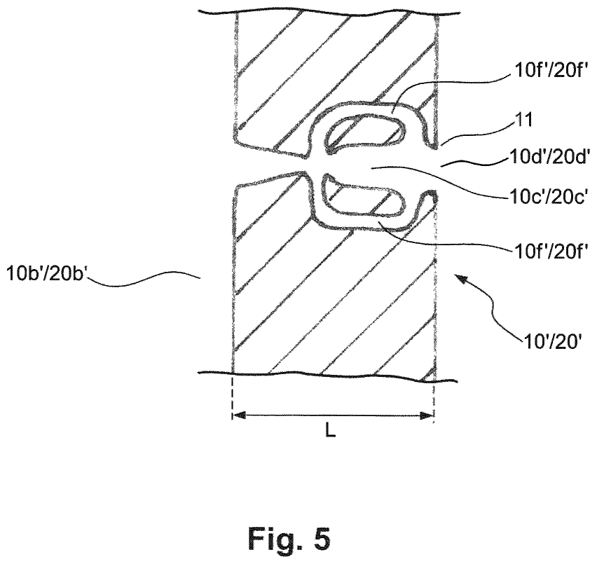

FIG. 5 shows a fluidic oscillator in the outlet duct of a hollow profile;

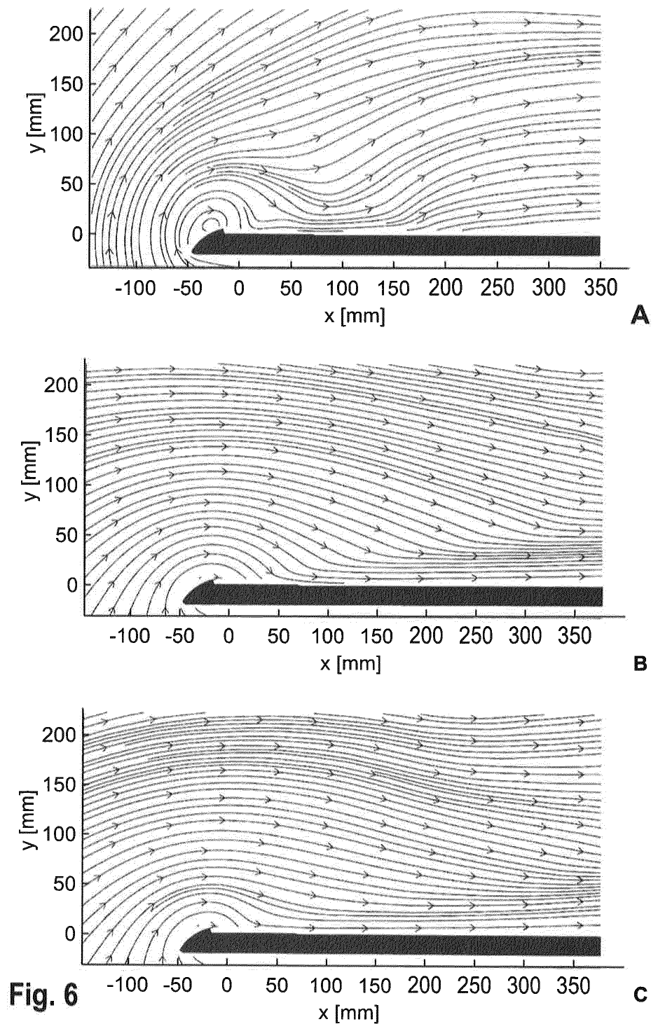

FIG. 6 shows the results of PIV measurements of the flow field of the wall jets in a conventional fume cupboard (FIG. 6A), in a fume cupboard with jet nozzles according to a preferred embodiment of the invention (FIG. 6B), and in a fume cupboard with OsciJet nozzles according to a further preferred embodiment of the invention (FIG. 6C);

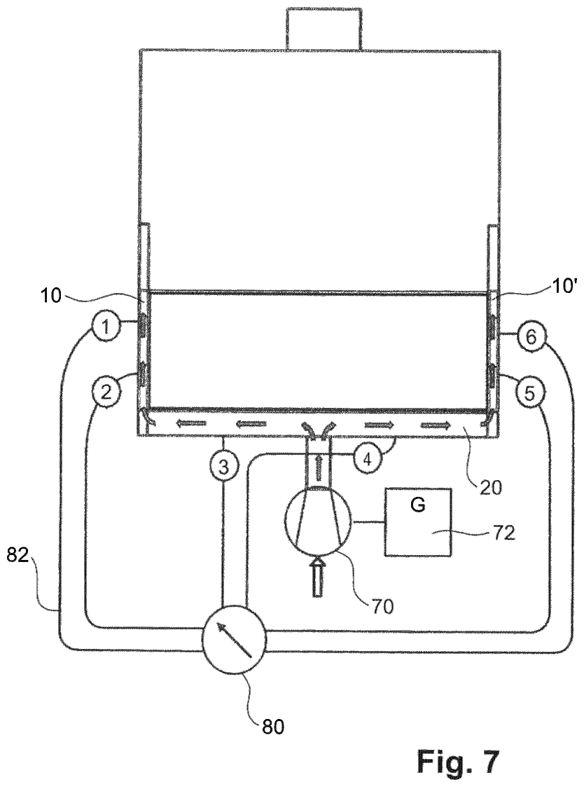

FIG. 7 shows a test setup to determine the static air pressure in the pressure chambers of the two side column profiles and the bottom profile;

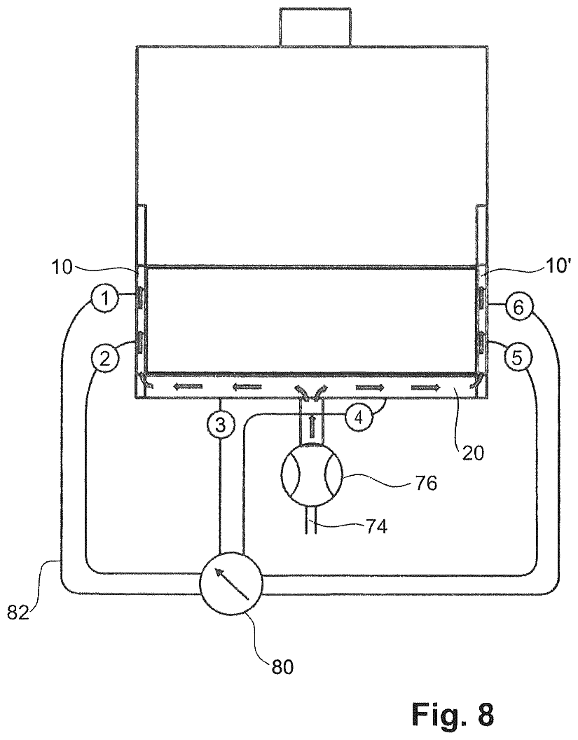

FIG. 8 shows a test setup to determine the volumetric flow rates of the wall jets coming from the side column profiles;

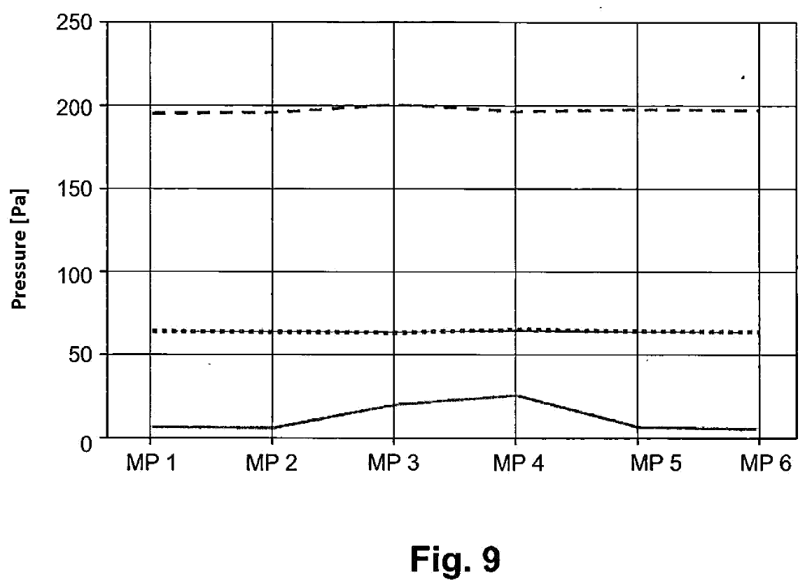

FIG. 9 shows the measurement results of static pressure in the pressure chambers of the side column profiles of a conventional fume cupboard (solid line), a fume cupboard with jet nozzles and OsciJet nozzles for different control voltages of the fan (dotted line and dashed line); and

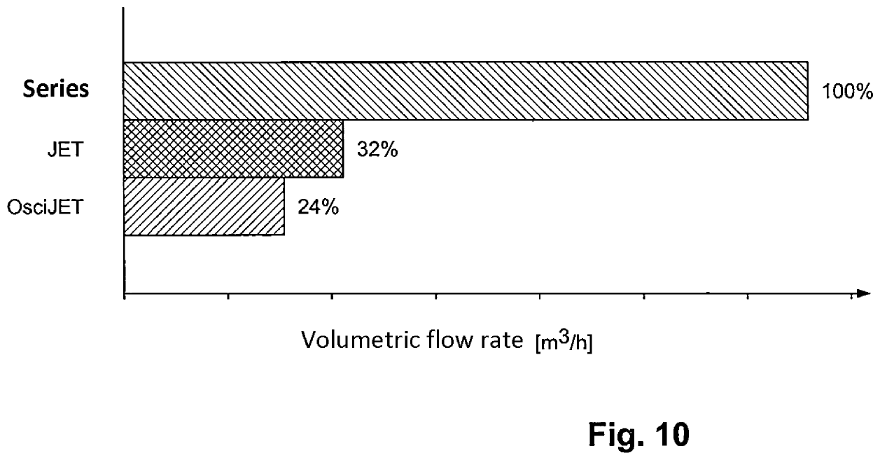

FIG. 10 is a diagram showing the reduction in the volumetric flow rates of the wall jets for different nozzle geometries of the side column profiles.

The perspective view of a fume cupboard 1 shown in FIG. 1 is roughly the same as the fume cupboard which has been marketed by the Applicant almost all over the world since about 2002 with the brand name Secuflow®. Thanks to the stabilizer jet technology described earlier, this fume cupboard needs an exhaust air volume flow of just 270 m³/(h·rm). This fume cupboard (designator: Secuflow® TA-1500) was used as the reference for the measurements taken in the context of the present invention, which are described later.

The basic layout of the fume cupboard according to the invention is largely similar to that of the fume cupboard 1 represented in FIG. 1. The fume cupboard according to the invention differs from the conventional Secuflow® fume cupboard in the nozzle geometry of hollow profiles 10, 20 and the way in which the compressed air jets 100, 200 emerging from hollow profiles 10, 20 are generated.

The fume cupboard 1 shown in FIG. 1 has a cupboard interior which is delimited at the rear preferably by a baffle wall 40, laterally by two side walls 36, at the bottom by a bottom plate 34 or work plate, at the front by a lockable front sash 30 and at the top preferably by a ceiling panel 48.

Front sash 30 is preferably of multipart construction such that when front sash 30 is opened and closed several vertically displaceable window elements slide behind one another telescopically. The front edge of the window element which is at the bottom when front sash 30 is in the closed position preferably has an aerodynamically optimized wing-like profile 32 (FIG. 2). Additionally, front sash 30 is preferably equipped with horizontally displaceable window elements, which allow laboratory personnel to access the interior of the fume cupboard even when front sash 30 is in the closed position.

At this point, it should be noted that front sash 30 may also be embodied as a two-part sliding window, both parts of which can be moved vertically in opposite directions. In this case, the parts moving in opposite directions are coupled to weights which counterbalance the mass of the front sash via cables or belts and pulleys.

A duct 63 is preferably located between baffle wall 40 and back wall 62 (FIG. 2) of fume cupboard housing 60 and leads to an exhaust air collecting duct 50 on the top of fume cupboard 1. Exhaust air collecting duct 50 is connected to an exhaust air system installed in the building. A furniture structure 38 is arranged underneath work plate 34 of the fume cupboard interior and serves as storage space for various laboratory instruments. For the purposes of the terminology used here, this furniture structure is to be understood to be a part of housing 60 of fume cupboard 100.

Hollow profiles 10 are provided on the frontal end faces of the side walls 36 of fume cupboard 1—the side walls are conventionally also called side columns. A hollow profile 20 is also provided on the frontal face of bottom plate 34.

When the phrase “on the frontal end face” is used in this document, the term is not be understood literally. Instead, it also refers to structures which are only provided or attached in the region of the frontal end face.

Similarly to the aerodynamically optimized wing profile 32 on the underside of the bottom front sash element 30, the wing-shaped leading edge 10a of the hollow profile 10 or the side column profile 10 (FIG. 4) is preferably aerodynamically optimized. The same preferably also applies for the hollow profile 20 on the front frontal end face of bottom plate 34. The wing-like profile geometry enables a low-turbulence, in ideal conditions even turbulence-free inflow of ambient air into the interior of the fume cupboard when front sash 30 is partly or fully open.

Hollow profiles 10, 20 serve to introduce, “stabilizer jets”—compressed air jets 100, 200 consisting of compressed air—are introduced into the interior of the fume cupboard along side walls 36 and bottom plate 34. These compressed air jets are conventionally generated by a fan 70 (FIG. 3) arranged underneath work plate 34 and inside housing 60. Although the exact arrangement of hollow profiles 10, 20 is difficult to make out in FIG. 2, hollow profiles 10, 20 are preferably positioned in front of the plane of the frontmost front sash element. Consequently, compressed air jets 100, 200 preferably only reach the interior of the fume cupboard when front sash 30 is partly or fully open.

The fume cupboard 1 represented in FIG. 1 is to be considered purely as an exemplary illustration, because the invention may be applied to various type of fume cupboard, such as bench-mounted fume cupboards, low-space bench-mounted fume cupboards, deep fume cupboards, walk-in fume cupboards or even mobile fume cupboards. As of the filing date of the present patent application, these fume cupboards also satisfy the DIN EN 14175 series of European standards in its current version. The fume cupboards may also satisfy other standards, such as ASHRAE 110/1995, which is valid for the US.

If reference is made to a standard in this description and these claims, the reference is always to the currently valid version of the standard. This is stated explicitly because it is known that the regulations set forth in the standards are becoming steadily more stringent, so that a fume cupboard which satisfies the current standard will also satisfy the regulations of an earlier standard.

FIG. 2 shows a highly simplified representation of the airflow pattern of the compressed air jets 100, 200 emerging from hollow profiles 10, 20 inside the fume cupboard interior and of the exhaust air in the duct 63 between baffle wall 40 and back wall 62 to the exhaust air collecting duct 50. The view in FIG. 2 corresponds a cross-sectional view along line A-A in FIG. 1.

As is shown in FIG. 2, baffle wall 40 is preferably arranged at a distance from work plate 34 at the bottom and preferably at a distance from back wall 62 of the housing, thus forming exhaust air duct 63. Baffle wall 40 preferably includes a multiplicity of elongated openings 42 (FIG. 1), through which the exhaust air or the air in the interior of the fume cupboard—which may carry a toxic burden—flows and is able to enter duct 63. Further openings 47 are preferably provided on the ceiling 48 in the interior of the fume cupboard, through which particularly light gases and fumes can be directed to exhaust air collecting duct 50.

Although not illustrated in FIG. 1 and FIG. 2, baffle wall 40 may also preferably be positioned at a distance from side walls 36 of fume cupboard housing 60. The gap formed thereby also enables exhaust air to flow through so that it can be guided into exhaust air duct 63.

A multiplicity of column retainers 44 are preferably provided on baffle wall 40 and may be affixed loosely in the rods to serve as holders for test setups in the interior of the fume cupboard.

As is shown in FIG. 3, in the conventional fume cupboard represented in FIG. 1 and FIG. 2, the air or stabilizer jets 100, 200 are generated by a fan 70 which is located underneath bottom plate 34 and preferably inside housing 60. The fan 70 which was used for the measurements that were conducted in the context of the present invention was a radial fan with single-sided suction manufactured by ebm Papst, with designator G1G097-AA05-01.

The compressed air generated by fan 70 is first fed into hollow profile 20 disposed in the region of the front frontal end face of bottom plate 34. The compressed air generated by the fan is preferably fed into hollow profile 20 at a point approximately in the middle of the lengthwise extension of the laterally aligned hollow profile 20. In this way, it is ensured that the pressure drop in hollow profile 20 is approximately symmetrical relative to this point.

FIG. 3 also shows that hollow profiles 10, 20 are fluidically connected to each other. Thus, some of the compressed air reaches both side column profiles 10 and is discharged from side column profiles 10 along side walls 36 into the interior of the fume cupboard in the form of stabilizer jets 100.

One might initially think that the energy consumption of fan 70 would worsen rather than improve the total energy balance of the fume cupboard, but in the Applicant's conventional Secuflow® fume cupboard the positive effect of the stabilizer jets 100, 200 made it possible to reduce the minimum exhaust air volumetric flow necessary to maintain the standard-specified escape prevention capability, i.e. the minimum volumetric flow that still satisfies the legal requirements regarding the escape prevention capability of the fume cupboard and which the exhaust air system installed in the building and connected to exhaust air collecting duct 50 must be able to generate. In this way, it was possible to lower the energy consumption of the fume cupboard by a greater amount than the energy consumption of the fan, which in turn has a positive effect on the total energy balance of the fume cupboard.

FIG. 4 shows the layout and geometry of a hollow profile 10, 20 constructed according to one embodiment of the invention in cross section, i.e. perpendicularly to the lengthwise extension of hollow profile 10, 20. The outer leading edge 10a, 20a is aerodynamically optimized with a wing profile. Inside hollow profile 10, 20 there is a pressure chamber 10b, 20b. The compressed air generated by fan 70 flows through pressure chamber 10b, 20b along the lengthwise extension of hollow profile 10, 20. A multiplicity of outlet openings 10d, 20d, through which the compressed air is able to escape into the interior of the fume cupboard are preferably also present along the lengthwise extension of hollow profile 10, 20.

The multiplicity of spatially separate outlet openings 10d, 20d are positioned in hollow profile 10, 20 in accordance with the intended purpose of the respective fume cupboard 1. They may be spread irregularly over the length of hollow profile 10, 20 or they may follow a specific pattern, or they may even be arranged equidistantly and regularly relative to each other.

The hollow profiles 10, 20 may preferably be constructed integrally with the respective side wall 36 and/or bottom plate 34, e.g., as an extruded aluminium profile. It is also conceivable to attach and affix or otherwise fasten hollow profiles 10, 20 to the frontal end face of the respective side wall 36 and/or bottom plate 34.

The multiplicity of outlet openings 10d, 20d—with or without outlet duct 10c, 20c—may also be inserted in the respective hollow profile 10, 20 in the form of a profile strip or constructed integrally therewith.

The geometry shown in FIG. 4 may be used both for the side column hollow profiles 10 and for the hollow profile 20 disposed on the front frontal end face of the work plate or bottom plate 34. To clarify the difference, in this description and the claims regarding the part, the side column profile is referred to as first hollow profile 10 and the bottom plate profile as second hollow profile 20.

In order to be able to compare the fluid dynamic characteristics of different ducts with different cross-sectional shapes through which a fluid flows, the “hydraulic diameter” is used. The term “hydraulic diameter” is well known to persons skilled in this field and serves as an operand which stands for that diameter of a flow duct having any cross section which manifests the same pressure loss for the same length and the same average flow velocity as a flow pipe with a circular cross section and the same diameter.

In the Applicant's conventional Secuflow® fume cupboard, the lengthwise dimension of outlet openings 10d, 20d, i.e. the extension of outlet openings 10d, 20d in the lengthwise direction of hollow profiles 10, 20 is equal to 30 mm, and the transverse dimension at right angles thereto is equal to 2 mm. For a rectangular outlet opening, the hydraulic diameter is calculated according to the formula dₕ=2ab/(a+b). If a=30 mm and b=2 mm, the hydraulic diameter of each outlet opening 10d, 20d in the conventional Secuflow® fume cupboard is equal to 3.75 mm and the surface area is 60 mm².

In contrast to this, according to a preferred embodiment of the invention the surface area of the hollow profiles 10, 20 shown in FIG. 4 preferably only has a value from 1 mm² to 4 mm², and preferably 1.8 mm² to 3 mm². In this context, outlet openings 10d, 20d may preferably have a circular, round, oval, rectangular or polygonal shape.

The lengthwise extension of the almost rectangular outlet openings 10d, 20d is preferably 3 mm, and the transverse dimension at right angles thereto is preferably 1 mm. This results in a hydraulic diameter of 1.5 mm. A hollow profile 10, 20 with outlet openings 10d, 20d of such designs was also used in the measurement series conducted as part of this invention. In the following text, these hollow profiles 10, 20 will also be referred to as “jet nozzles”.

According to another aspect of the invention, at least one outlet opening 10d, 20d, and preferably all outlet openings 10d, 20d provided in hollow profile 10, 20 communicate fluidically with pressure chamber 10b, 20b via a duct 10c, 20c which has a length L (FIG. 4).

In the hollow profile 10a, 20a shown in FIG. 4, length L of the duct is preferably 9 mm. The ratio of length L to the hydraulic diameter (1.5 mm) is thus equal to 6.

The measurement series conducted as part of the present invention suggest that the duct 10c, 20c communicating fluidically with preferably each outlet opening 10d, 20d should have a length L which is at least 3 times, preferably 4 times to 11 times the value of the hydraulic diameter of outlet opening 10d, 20d. Only with a duct length L that satisfies this condition is it possible to introduce compressed air jets into the interior of the fume cupboard for which a direction can be “specified” that is significantly more pronounce than for air jets which must only pass through a shorter duct. As a consequence, the opening angle of the compressed air jets 100, 200 spreading in the interior of the fume cupboard becomes smaller. In other words, at the time they emerge from outlet openings 10d, 20d, compressed air jets 100, 200 are already directed strongly enough to ensure that they remain as close as possible along side walls 36 and bottom plate 34.

Unlike this situation, the extruded aluminium hollow profiles 10, 20 used in the conventional Secuflow® fume cupboard have a thickness of 2 mm, i.e., the duct had a length L of just 2 mm before the outlet opening. The ratio of the length L to the hydraulic diameter (3.75 mm) was this considerably less than 1.

Angle α (FIG. 4), which the preferably straight duct 10c, 20c forms relative to side wall 36 and/or bottom plate 34, is preferably in a range from 0° to 10°. It should be noted at this point that an air jet passing through a duct which is at an angle of 0° to the associated side wall or bottom plate will not propagate absolutely parallel to the side wall or the bottom plate in the interior of the fume cupboard. This is due to the fact that the average velocity vector will always tend to form an angle greater than 0° with side wall 36 or bottom plate 34 even if it is blown out parallel thereto.

According to a further preferred embodiment of invention, instead of a duct 10c, 20c running in a straight line from pressure chamber 10b, 20b to outlet opening 10d, 20d (FIG. 4), an outlet geometry as represented in FIG. 5 is provided, which enables a preferably periodically oscillating compressed air jet to be discharged. In the following text, this nozzle geometry will also be referred to as OsciJet.

In this context, it should be noted that the section shown in FIG. 5 corresponds approximately to the subarea indicated by dashed lines in FIG. 4, so that the other features of the hollow profiles 10, 20, which were explained with reference to FIG. 4, may also be transferred to the hollow profiles 10′, 20′ of FIG. 5.

The periodic oscillation is preferably generated by self-excitation and preferably with the aid of non-moving parts, which are preferably constructed integrally with hollow profile 10′, 20′. For this purpose measurements were taken in the course of the present invention with the aid of “fluidic oscillators”.

A distinctive feature of fluidic oscillators is that they generate a self-excited oscillation in the fluid passing through them. This oscillation results from the division of the fluid stream into a main stream and a substream. Whereas the main stream flows through the main duct 10c′, 20c′, the substream flows alternatingly through one of the two secondary ducts 10f′, 20f′ (FIG. 5). The substream meets the main stream again in the region of outlet opening 10d′, 20d′ and diverts it down or up in alternating manner depending on which secondary duct 10f′, 20f′ the substream passed through previously. The alternatingly fluctuating pressure conditions in secondary ducts 10f′, 20f′ cause the substream to flow through the respective other secondary duct 10f′, 20f′ in the next cycle. This in turn causes a deflection in the respective opposite direction of the re-merging main stream and substream in the region of outlet opening 10d′, 20d′. The processes are then repeated.

With the nozzle geometry of FIG. 5 as well, outlet opening 10d′, 20d′ communicates fluidically with a pressure chamber 10b′, 20b′ via a duct 10c′, 20c′ (in this case the main duct), which has a length L. Here too, duct length L is at least 3 times, preferably 4 to 11 times greater than the hydraulic diameter of outlet opening 10d′, 20d′. In a preferred embodiment of the invention, the lengthwise extension of the substantially rectangular outlet opening 10d′, 20d′ is equal to 1.8 mm and its extension at right angles thereto is equal to 1 mm. This results in a hydraulic diameter of 1.3 mm. Duct length L is preferably 14 mm and thus about 11 times greater than the hydraulic diameter.

As an alternative to the OsciJet nozzle geometry, nozzle geometries are conceivable which generate a non-periodic compressed air jet. In other words, such nozzle geometries produce a compressed air jet which sweeps back and forth with a stochastic motion. To produce non-periodic compressed air jets of such kind, reflux free fluidic components may be used, unlike those used in fluidic oscillators.

FIG. 6 shows the result of PIV measurements of the flow field of the wall jets discharged from side column profile 10 using the conventional nozzle geometry of the Secuflow® fume cupboard (FIG. 6A), the jet nozzle geometry (FIG. 6B) and the OsciJet nozzle geometry (FIG. 6C). In the measurements shown in FIG. 6, the fan voltage was 9.85 V.

FIG. 6a clearly shows how the ambient air flowing through the open front sash delaminates from the side wall about 150 mm behind the plane of the front sash, which corresponds to the 0 position, despite the action of stabilizer jets 100 from hollow profile 10. This delamination was not observed in previous experiments, in which mist was used. Such delamination is not discernible in FIG. 6b and FIG. 6c. In FIG. 6B and FIG. 6C, the ambient air flows along the side wall without turbulence or forming backflow areas. The density of the field lines, which is an indicator of higher air speeds, is also significantly greater in the region of the side wall in FIG. 6B and FIG. 6C than in FIG. 6A. This leads to the conclusion that the ambient air flows towards the baffle wall of the fume cupboard interior considerably faster in the case of the jet nozzle geometry (FIG. 6B) and the OsciJet nozzle geometry (FIG. 6C) than with the conventional nozzle geometry of the Secuflow® fume cupboard (FIG. 6A). FIG. 6B and FIG. 6C also show clearly how the ambient air is drawn towards the side wall by a suction-like force even at a distance from the side column profile 10, 10′ (y-axis), whereas in FIG. 6A the ambient air tends rather to veer away from the side wall.

The PIV measurements of the flow field thus show very clearly that airflow delaminations can be prevented very effectively with both the Jet nozzle (FIG. 4) and the OsciJet nozzle (FIG. 5). Moreover, the inflowing ambient air follows the wing-like contour in the front region of the side column better, thereby further reducing the risk of backflow.

A series of PIV measurements were conducted with different control voltages of fan 70 (FIG. 3). In this context, a higher control voltage is associated with a higher blowing speed of the stabilizer jets. The PIV measurements showed clearly that the object of avoiding airflow delaminations is achieved still more effectively at higher stream velocities. In order to realize this aspect of the invention, it is sufficient if an airflow delamination is prevented in a region of the front of the work area at least as far as 25% of the depth of the work area. This corresponds to the region of the work area which is categorized as particularly critical with regard to dangerous backflow areas. This value is preferably at least 50%, more preferably 75%.

After experimentally determining the control voltage of fan 70 at which a practically turbulence-free flow route without significant backflow areas was observed, the inventors turned to the question of what minimum volumetric flow rate would be needed to enable a turbulence-free flow field to be reproduced.

Given the small dimensions of the Jet and OsciJet nozzle outlet openings 10d, 20d and 10d′, 20d′, a measurement of the air outlet velocity using a hot-wire anemometer is not able to return reproducible results. In the case of the OsciJet nozzles, the hot-wire anemometer even oscillates together with the periodically oscillating stabilizer jets.

According to a further aspect of the invention, a method was then developed for determining the minimum volumetric flow rates. The associated test setup is represented in FIGS. 7 and 8.

In this context, the volumetric flow rate of the wall jets is determined in two steps. As shown in FIG. 7, a voltage regulator 72 is used to adjust the control voltage of fan 70 to a value at which the flow field of the wall jets exhibits practically no significant airflow delaminations, as verified with the aid of PIV measurements. Then, the static pressure inside hollow profiles 10, 10′ and 20, 20′ is determined at measurement points 1, 2, 3, 4, 5 and 6. For this purpose, a pressure transducer 80 is used which preferably measures the static pressure in pressure chambers 10a, 10a′ and 20a, 20a′ of hollow profiles 10, 10′ and 20, 20′ via respective pressure transducer lines 82. The pressure transducer lines 82 are preferably arranged such that the ends thereof closest to the pressure chambers terminate flush with an inner surface of the respective pressure chamber 10a, 10a′ and 20a, 20a′. In this first measurement step, solely for exemplary purposes a hollow profile 10 with jet nozzles is used on the left side column, and a hollow profile 10′ with OsciJet-nozzles is used on the right side column.

In a second measurement step, as shown in FIG. 8, fan 70 is replaced with a compressed air connection 74. A calibrated pressure reducer or mass flow controller 76 is arranged downstream of compressed air connection 74. The mass flow controller used here was manufactured by Teledyne Hastings Instruments, series 201. After adjusting the static reference air pressure in hollow profiles 10, 10′ and 20, 20′ as determined in the first measurement step, the mass flow regulator may then be used to determine the associated mass flow. The volumetric flow can be calculated from the mass flow by taking into account the ambient pressure and ambient temperature.

FIG. 9 shows the static air pressures measured in pressure chambers 10a, 10a′ of hollow profiles 10, 10′. The solid line at bottom is only supplied for comparison purposes and shows the static air pressure in the hollow profile of the Secuflow® series fume cupboard, with a fan voltage of 4.41 V. The average static air pressure in this case is 12.5 Pa. The dotted line indicates an average value of 65 Pa and was determined for the Jet and OsciJet nozzles with a fan voltage of 4.41 V. The dashed line at top corresponds to an average air pressure of 197 Pa. This was determined for a fan voltage of 9.85 V using the Jet and OsciJet nozzles. It should be noted at this point that the average static air pressures measured inside the series profile of the Secuflow® fume cupboard with a fan voltage of 9.85 V are not shown in FIG. 9.

The volumetric flow rates derived therefrom are shown in FIG. 10. With the optimized Jet and OsciJet wall jet nozzles, the required minimum volumetric flow rate with the Jet configuration is 68% lower than with the Secuflow® fume cupboard and 76% lower than the Secuflow® fume cupboard with the OsciJet configuration.

According to a further aspect of the invention, the inventors have concluded that given the substantially reduced volumetric flows it may now be possible to run a fully functional fume cupboard, i.e. a fume cupboard that fulfills the requirements of the DIN EN 14175 standard series, in compliance with the regulations using a compressed air system which is typically present in buildings. The person skilled in the art is aware that such compressed air systems installed in buildings are usually able to supply an air pressure in a range from 0 to 7 bar. Accordingly, an electrically powered fan may be dispensed with.

According to the invention, not all outlet openings 10d, 10d′ of side column profile 10, 10′ and not all outlet openings 20d, 20d′ of bottom plate profile 20, 20′ which are intended for the output of wall jets 100 or bottom jets 200 in the respective hollow profile 10, 20 have to have the nozzle geometry represented in FIG. 4 or FIG. 5 in order to embody the object described in the patent claims. It is therefore sufficient if at least one outlet opening 10d, 10d′ of side column profile 10, 10′ and/or at least one outlet opening 20d, 20d′ of bottom plate profile 20, 20′ is/are constructed in such manner. The same applies for length L of duct 10c, 10c′ and 20c, 20c′, which is provided immediately upstream of the respective outlet opening 10d, 10d′ and 20d, 20d′.

1-20. (canceled)

21. A fume cupboard for a laboratory, the fume cupboard comprising a housing in which a work area is located, delimited in the front by a front sash, at the bottom by a bottom plate and on each side by a side wall, and having a first hollow profile disposed on a front frontal end face of each side wall, wherein each first hollow profile contains a first pressure chamber which is in fluid communication with a multiplicity of first openings, from which air jets in the form of wall jets consisting of compressed air can be output into the work area along the respective side wall, wherein the size of the first openings and the air pressure that prevails in the first pressure chamber during proper use of the fume cupboard are selected such that the first pressure chamber can be connected fluidically to a compressed air system installed in the building without airflow delamination of the wall jets from the side wall in a region extending from a front side of the work area at least as far as 25% of the depth of the work area.

22. A fume cupboard according to claim 21 having a second hollow profile disposed on a front frontal end face of the bottom plate, wherein the second hollow profile contains a second pressure chamber which is in fluid communication with a multiplicity of second openings, from which air jets in the form of bottom jets consisting of compressed air may be output into the work area along the bottom plate, wherein the size of the second openings and the air pressure that prevails in the second pressure chamber during proper use of the fume cupboard are selected such that the second pressure chamber can be connected fluidically to a compressed air system installed in the building without airflow delamination of the wall jets from the bottom plate in a region extending from a front side of the work area at least as far as 25% of the depth of the work area.

23. A fume cupboard according to claim 21, wherein no airflow delamination of wall jets from the side wall or of the bottom jets from the bottom plate occurs in a region extending from the front side of the work area at least as far as 50% of the depth of the work area.

24. A fume cupboard according to claim 21, wherein no airflow delamination of the wall jets from the side wall or of the bottom jets from the bottom plate occurs in a region extending from the front side of the work area at least as far as 75% of the depth of the work area.

25. A fume cupboard according to claim 21, further comprising a first and/or a second pressure transducer which is/are fluidically connected to the first and/or the second pressure chamber.

26. A fume cupboard according to claim 25, wherein the first and/or the second pressure transducer comprises a first and/or a second pressure transducer line, which is/are routed in such manner that an end of the first and/or second pressure transducer line closest to the pressure chamber terminates flush with an inner surface of the first and/or the second pressure chamber.

27. A fume cupboard according to claim 21, further comprising a control device which during proper operation of the fume cupboard sets the pressure of the first and/or second pressure chamber in a range from 50 Pa to 500 Pa.

28. A fume cupboard according to claim 27, further comprising a first and/or a second pressure which is/are fluidically connected to the first and/or the second pressure chamber, the control device being connected electrically to the first and/or the second pressure transducer.

29. A fume cupboard according to claim 27, wherein the control device is a pressure reducer or a mass flow controller, which is arranged upstream of the first and/or second pressure chamber.

30. A fume cupboard according to claim 29, wherein the pressure reducer or the mass flow controller is arranged inside the housing.

31. A fume cupboard according to claim 21, wherein, when viewed at right angles to the direction of flow, a cross-sectional area of at least one of the first and/or second openings is in a range from 1 mm² to 4 mm².

32. A fume cupboard according to claim 21, wherein, when viewed at right angles to the direction of flow, a cross-sectional area of at least one of the first and/or second openings is in a range from 1.8 mm² to 3 mm².

33. A fume cupboard according to claim 21, wherein at least one of the first and/or the second openings is/are configured in such manner that the compressed air jet exiting the first and/or second opening is discharged into the work area as a periodically oscillating wall jet and/or as a periodically oscillating bottom jet.

34. A fume cupboard according to claim 33, wherein the periodicity is in a range from 1 Hz to 100 kHz.

35. A fume cupboard according to claim 33, wherein the periodic oscillation of the wall jets and/or the bottom jet is formed exclusively by non-moving parts of the first and/or second hollow profile.

36. A fume cupboard according to claim 33, characterized in that the periodic oscillation of the wall jets and/or the bottom jet is generated by self-excitation.

37. A fume cupboard according to claim 33, further comprising a first and/or a second fluidic oscillator which is/are furnished with the first and/or the second opening and which generate(s) the periodic oscillation of the one or more wall jets and/or the periodic oscillation of the one or more bottom jets.

38. A fume cupboard according to claim 21, wherein the first and/or second openings have a circular, round, oval, rectangular or polygonal shape.

39. A fume cupboard according to claim 21, wherein at least a first and/or a second opening is/are fluidically connected to the first and/or the second pressure chamber via a first and/or a second elongated duct, and that the first and/or second duct has a length L at least 3 times greater than the hydraulic diameter of a cross-sectional surface of the associated opening when viewed at right angles to the direction of flow.

40. A fume cupboard for a laboratory, the fume cupboard comprising a housing in which a work are is located, delimited in the front by a front sash, at the bottom by a bottom plate and on each side by a side wall, and having a second hollow profile disposed on a front frontal end face of the bottom plate, wherein the second hollow profile contains a second pressure chamber which is in fluid communication with a multiplicity of second openings, from which air jets in the form of bottom jets consisting of compressed air may be output into the work area along the bottom plate, characterized in that the size of the second openings and the air pressure that prevails in the second pressure chamber during proper user of the fume cupboard are selected such that the second pressure chamber can be connected fluidically to a compressed air system installed in the building without airflow delamination of the wall jets from the bottom plate in a region extending from a front side of the work area at least as far as 25% of the depth of the work area.
